(19) United States
(12) Patent Application Publication
(10) Pub. No.: US 2019/0340540 A1
(43) Pub. Date: Nov. 7, 2019

(54) ADAPTIVE CONTINUOUS LOG MODEL LEARNING

(71) Applicant: NEC Laboratories America, Inc., Princeton, NJ (US)

(72) Inventors: Jianwu Xu, Titusville, NJ (US); Hui Zhang, Princeton Junction, NJ (US)

(21) Appl. No.: 16/400,426

(22) Filed: May 1, 2019

Related U.S. Application Data
(60) Provisional application No. 62/664,987, filed on May 1, 2018.

(51) Int. Cl. G06N 20/20; G06F 11/34

(52) U.S. Cl. CPC G06N 20/20; G06F 11/3495; G06F 11/3476

(57) ABSTRACT

Systems and methods for adaptive and continuous log model learning can include updating a core model to generate an updated core model, each being a syntactic model and being additive in nature, based on a heterogeneous training log file and updating a peripheral model, that represents a relationship between core models, using a set of existing auxiliary files, that define can define relationship between existing models, and the updated core model to generate an updated peripheral model based on the heterogeneous training log file. Additionally, they can include detecting, with the updated core model and the updated peripheral model, an anomaly within a set of testing logs indicative of information technology system operation to take remedial action on the information technology system based on a most recent model update.

### RELATED APPLICATION INFORMATION

This application claims priority to U.S. Provisional Patent Application No. 62/664,987, filed on May 1, 2018, incorporated herein by reference herein its entirety.

### BACKGROUND

### Technical Field

The present invention relates to systems and methods for adaptive continuous log model learning and more particularly to updating heterogenous log models of IT system operation.

### Description of the Related Art

Heterogeneous IT operational logs can be used as inexpensive proxies for recording and indicating the health status of various types of IT systems including enterprise computer systems, cloud computing systems, and personal computer systems. Many log processing and management systems are designed to analyze, understand, and manage complex IT systems based on their operational logs. To quantify and capture the underlying dynamics of the system, models can be built from large amounts of training logs obtained from the operation of the IT system.

When the log processing and management system is deployed and new logs are continuously tested against the models built from the previous segment of operational logs, it is useful to update the models with the latest logs to continuously obtain and account for the latest system dynamics. However, the computational cost of model training from large amounts of operational training logs tends to get very high. If the model updating procedure re-trains the models from the new training logs in their entirety, then the procedure often uses intensive computational resources and tends to incur a large cost.

### SUMMARY

According to an embodiment of the present invention, a method is provided for adaptive and continuous log model learning including updating, by a processor device, a core model to generate an updated core model based on a heterogeneous training log file where each of the core model and the updated core model can be a syntactic model and can be additive in nature. The method includes updating a peripheral model, that can represent a relationship between core models, using a set of existing auxiliary files that can define a relationship between existing models, and the updated core model to generate an updated peripheral model based on the heterogeneous training log file. Additionally, the method includes detecting, with the updated core model and the updated peripheral model, an anomaly within a set of testing logs indicative of information technology system operation to take remedial action on the information technology system based on a most recent model update.

According to another embodiment of the present invention, a system is provided for adaptive and continuous log model learning including a processor device, at least one database storing log models, at least one log file storage, and at least one auxiliary file storage. The system, according to the embodiment, also includes an update module configured to update a core model to generate an updated core model, where each of the core model and the updated core model can be a syntactic model and can be additive in nature, based on a heterogeneous training log file, and to update a peripheral model, which can represent a relationship between core models, using a set of existing auxiliary files, which can define a relationship between existing models, and the updated core model to generate an updated peripheral model based on the heterogeneous training log file. The system can also include an anomaly detection module configured to detect, with the updated core model and the updated peripheral model, anomalies within a set of testing logs indicative of information technology system operation.

According to yet another embodiment of the present invention, a computer program product for adaptive and continuous log model learning is provided that comprises a non-transitory computer readable storage medium having program instructions embodied therewith that are executable by a computing device to cause the computing device to update a core model to generate an updated core model based on a heterogeneous training log file, where each of the core model and the updated core model can be a syntactic model and can be additive in nature, and update a peripheral model, which can represent a relationship between core models, using a set of existing auxiliary files, which can define a relationship between existing models, and the updated core model to generate an updated peripheral model based on the heterogeneous training log file. Further, when executed, the instructions can cause the computing device to detect, with the updated core model and the updated peripheral model, an anomaly within a set of testing logs indicative of information technology system operation to take remedial action on the information technology system based on a most recent model update.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a system and method for adaptive and continuous log model learning, in accordance with an embodiment of the present invention;

FIG. 2 is a block/flow diagram illustrating core model updating, in accordance with an embodiment of the present invention;

FIG. 3 is a block/flow diagram illustrating peripheral model updating, in accordance with an embodiment of the present invention;

FIG. 4 is a block/flow diagram illustrating the generation of updated auxiliary files, in accordance with an embodiment of the present invention;

FIG. 5 is a block/flow diagram illustrating system anomaly detection, in accordance with an embodiment of the present invention;

FIG. 6 is a schematic and block diagram illustrating a high-level system for adaptive and continuous log model learning, in accordance with an embodiment of the present invention; and

FIG. 7 is a block diagram illustrating a high-level system for adaptive and continuous log model learning, in accordance with an embodiment of the present invention.

### DETAILED DESCRIPTION OF PREFERRED EMBODIMENTS

In accordance with the various embodiments of the present invention, systems and methods are provided for adaptive and continuous log model learning.

The systems and methods presented in accordance with the various embodiments of the present invention provide ways to continuously modify log models in an adaptive manner based on the latest logs obtained from an operative IT system. In the various embodiments, a new set of models, is not reproduced from scratch every time a new set or segment of training logs becomes available. Instead, a subset of core models can be modified without using the entirety of the new training logs.

To accomplish this, the various embodiments of the present invention automatically discover and identify the pertinent subsets of the new training logs containing new and useful information that can be extracted from the new training logs and added to the core models. In this manner, the various embodiments of the present invention can save a significant amount of computational resources, time, and financial cost without sacrificing any of the quality and correctness of the updated models as well as thereby improving the efficiency of the operation of the log analytics system as well as the underlying IT system.

The various embodiments of the present invention provide a solution to address issues with model updating in any general log analytics system. The embodiments present a faster and a more efficient model updating mechanism by removing or reducing the requirement of having to store the entirety of the new training log sets. In this manner, the various embodiments of the invention also reduce the computational cost of updating the models.

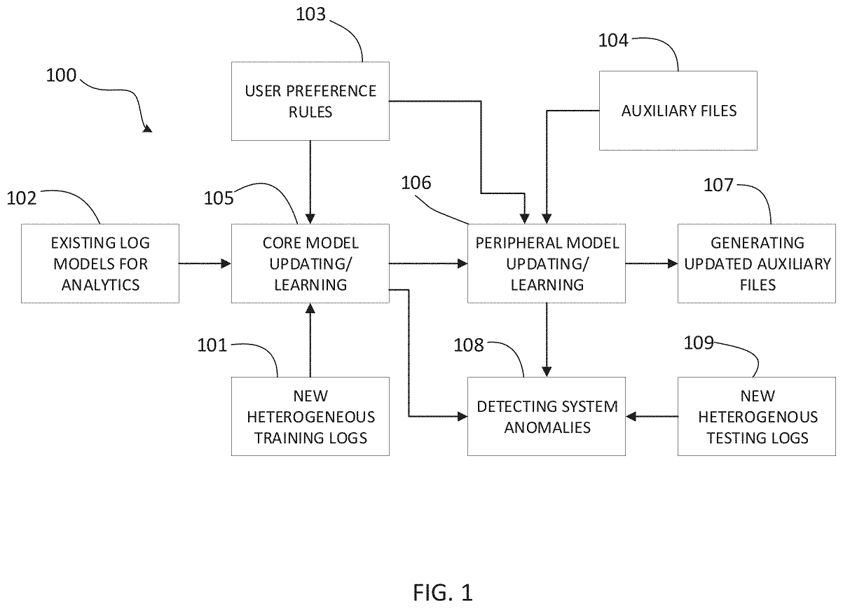

Referring now in detail to the figures in which like numerals represent the same or similar elements and initially to FIG. 1, a high-level system/method for adaptive and continuous log learning is presented in accordance with an embodiment of the present invention. Throughout this description, embodiments of the present invention may be referred to as an Adaptive Log Model Learning System (ALMLS) 100. Generally, the embodiments of the present invention include new heterogenous training logs of block 101 that can be used as input in the core model updating/learning process of block 105 that can update existing log analytic models of block 102 which may include core models and peripheral models.

Because of the additive feature or nature of the core models, it is possible to efficiently add new core models into the existing core models while also updating the peripheral models. By dividing the log analytics models into two parts, namely, a core part and a peripheral part, the various embodiments of the invention provide a novel method for the flexible adaptation of new training logs to deal with the changing dynamics of log systems.

Furthermore, the embodiments provide a method and capability which enables users to remove certain parts of previous models from the final updated model set based on the users' preferences or domain knowledge. Accordingly, during or prior to the updating/learning process 105, which may be implemented by an update module discussed in more detail below, the embodiments of the present invention may apply user preference rules 103 selected by a user that may add certain models to or remove certain models from the updating/learning of core models in block 105 and from the updating/learning of peripheral models in block 106. In this regard, the various embodiments of the present invention can also provide the functionality and interface for users to explicitly select and or discard any old models that may be inapplicable for dealing with system changes.

Generally, the various embodiments the present invention can identify a core model from a list of multiple training models that can include, but are not limited to, syntactic regular expression models, semantic content models, statistical models, sequence models, ordering models, and cross-component invariant models. The embodiments can also automatically discover the portion of new training logs which contain the new and useful information for updating the models. This portion can then be used to update the models without having to recreate the entire model set, which, in turn, reduces the burden and computational cost of the process. Because the core models are additive, new models that are built from the subset of the new training logs can be directly added into the existing core models. This procedure makes core model updating much more straightforward and efficient.

Thereafter, the non-core models, also referred to as peripheral models, can be modified once the core model update process is complete. Notably, the separation of and differentiation between core models and non-core models makes the entire approach of log analytic model updating adaptive and robust against a variety of potential system configuration changes. Accordingly, the embodiments of the present invention can include the use of auxiliary files of block 104 in defining the relationships between core models represented by the peripheral models to facilitate the peripheral model learning/updating process of block 106. In addition, the peripheral model learning/updating process of block 106 may also entail the generation of updated auxiliary files in block 107.

After updating all of the models in accordance with the new training log set, system anomaly detection can be performed on a testing log set based on the updated log models. Thus, the updated core models and peripheral models can be used to detect anomalies in block 108, which may be implemented by an anomaly detection module described in more detail below, on the operation of an IT system based on new heterogeneous testing logs of block 109 so that corrective or remedial actions can be taken, if necessary, either automatically or by the users of the IT system to address the cause of the anomalies.

Because the core models of the log analytics systems are additive, the core models can include both normal system operation models and abnormal system state models that remain relevant and applicable even during system configuration changes or instances of failure. Consequently, in each respective system state the part of the core model that is relevant will be triggered while the remaining part of the core model will stay dormant. Accordingly, the system anomaly detection of block 108 can help distinguish between known normal system operation states, system faults, and previously unencountered normal system operation states. Therefore, it is beneficial to make the core model as comprehensive and up-to-date as possible in order to capture all of the system dynamics that may be involved.

With continued reference to FIG. 1, given an input of heterogeneous logs 101 that may be presented in the form of a heterogeneous log file, block 105 of the ALMLS which includes a core model learning component, can update the core models of the log analytic system. As mentioned earlier, efficiency is realized in this portion of the process by virtue of the additive nature of the core models obviating the need for the entirety of the models to be recreated and only focusing on certain subsets of the models that can be added or appended to the existing models.

Thereafter, once the core model updating/learning is complete in block 105, peripheral model learning can be performed in block 106 which uses existing auxiliary files 104 as well as the output from the core model learning process of block 105 to update the peripheral models. Optionally, users' preference rules 103 can be applied at this point in the process of the ALMLS if a user desires to exercise the option of removing any specific part of a model from a particular segment of the set of training logs.

Subsequently, with the processes of block 105 and 106 completed, the auxiliary files are updated in block 107, which can then be used in a subsequent round of ALMLS processing. Thereafter, in block 108, system anomalies can be detected using the newly updated sets of core models and peripheral models by applying them to a new set of heterogeneous testing logs from block 109.

With continued reference to core model updating/learning 105 and peripheral model updating/learning 106 of FIG. 1, the elements and processes discussed above are now described in more detail. In an embodiment of the present invention, the set of new training logs 101 is provided for the purpose of training and updating the existing sets of models 102. In the embodiment, a new set of logs 101 is collected from the operation of an IT system as a log analytics system is deployed for analyzing the new testing logs 109. An illustrative example may be a live on-line software system may continue to produce heterogenous logs from its various components. Alternatively, the IT system may be a factory or power plant, the various sensors and component devices and machines continuously produce a variety of heterogeneous logs describing the operation and status of the sensors and machinery contained therein. Analogously, an operative IT system may be a cloud computing system including servers connected to a variety of other networked devices. Yet another example of an IT system contemplated for use with the embodiments of the present invention may be a personal computer, the internal components and connected devices of which likewise produce sets of heterogeneous logs that are indicative of the operation and states of the personal computer system. Therefore, based on the underlying dynamics of the IT system, a segment of the training logs could be logs that were accumulated during a certain time period. Alternatively, a segment of the training logs could be selected that are pertinent to a particular set of components or subcomponents of the IT system. A person of skill in the art will appreciate that there are a variety of ways according to which a segment of the training logs could be selected from the operation of the IT system. In some embodiments of the present invention, each segment or a sampled segment of the set of the logs obtained from the IT system can be used as the new training log set to update the log analytics model in accordance with the desired frequency of model updating.

In one embodiment, the log analytics models can be divided into a core model part and a peripheral model part. The core model part can include syntactic log models (i.e., logs that follow a particular syntax or format). In some embodiments the syntactic model is the structure of the heterogeneous logs and can be represented by regular expressions. Thus, the syntactic models can be used later to parse logs into existing patterns and extract content from the individual fields of the model. The following regular expression is an example of syntactic model used in the log analytic system:

%{IP:P1IP1}%{WORD:P1W1}%{BASE16NUM:P1F1}%{HLA_TS_1:ts1}%{NOTSPACE:P1NS1} (1)

This regular expression can be matched to the following sample log:
128.0.0.100 Status 100 2017/03/24 14:20:12 success123

Syntactic log models are independent of each other allowing the core models to have an additive nature. Therefore, in the embodiments of the present invention, any new valid log patterns identified from the set of testing logs can be added directly into the existing syntactic models/core models.

The other part of the existing models that does not form the core models is referred to herein as the peripheral model part. The peripheral model part includes semantic content models, statistical models, sequence models, ordering models, cross-component invariant relationship models, and the like. Unlike the core models which are syntactic in nature, the peripheral models are non-additive and have a discriminative nature. To assist in the model updating process for the peripheral models, the ALMLS accesses auxiliary files in block 104 which may have been stored after a previous model training phase. The auxiliary files can contain processed and re-organized training logs from a previous training phase or updating phase. In some embodiments, the auxiliary files can be stored in a network file system (NFS) location which can be accessed during the model updating phase.

In embodiments of the present invention, the separation of log analytics system models into core and peripheral parts makes the adaptive log model learning computationally efficient and flexible allowing for the options of users' preference of selection of certain segment of training logs to be taken into consideration. In some embodiments, the existing log analytics models can be stored in a NoSQL database which may use key value pairs to manage the necessary information.

The application of user's preference rules in block 103 is optional in the processes of the ALMLS system and allows for customization of the model updating process in accordance with user desires or domain knowledge. In accordance with some embodiments of the present invention, as the log analytics system models continue to adapt and evolve, it is possible that the underlying IT system (e.g., computer/communication system) changes the states, begins operating in a different fashion, or is found to be in a different situation than it was previously. To account for such potential discrepancies ALMLS provides an option to users for removal of any segment of models from the final log analytics models that may be representative of such differences and should not be included in the updating process. The training logs can have segment lables which correspond to a portion of the logs that are to be used for training the log analytics system models. Therefore, users can use the segment labels as indicators for the removal of certain additive models or auxiliary files from the process of training the final models. In some embodiments of the present invention, an interface can be provided to the users to input the desired segment label for inclusion or exclusion from the updating/learning/training processes.

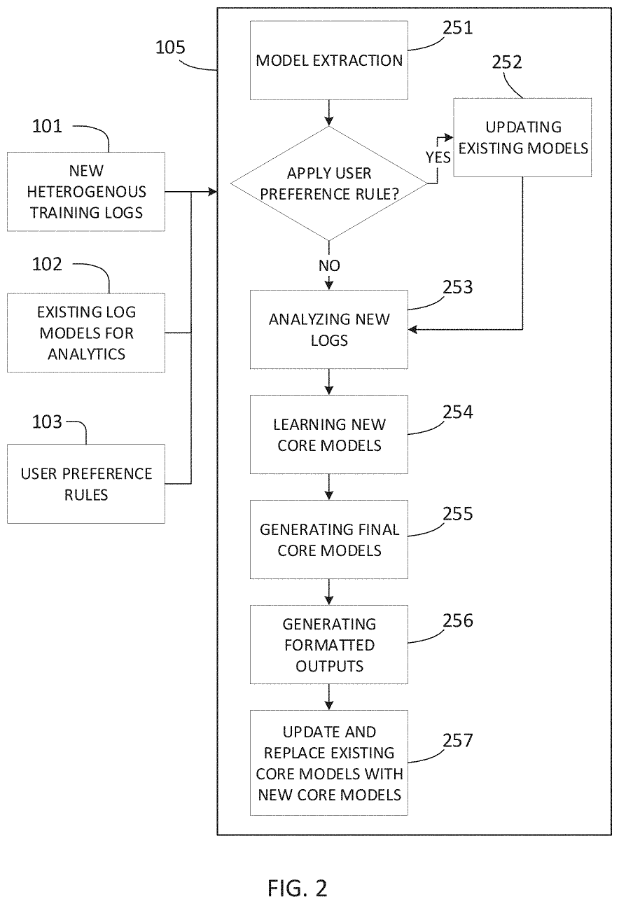

Turning now to FIG. 2, a block/flow diagram is depicted presenting the primary workflow of the core model updating process of block 105 in accordance with an embodiment of the present invention. The core model(s) of the log analytics system is/are updated in block 105 which also produces the intermediate files for the subsequent updating of the peripheral models in block 106. Block 105 receives heterogenous training logs from block 101, existing log analytics models from block 102, and option user preference rule selection from block 103 as inputs for the performance of the core model updating process.

At the outset, the existing core models are extracted in block 251. Because the existing log analytics models of block 102 can be stored and managed in a NoSQL database, the models can initially be extracted into local files. Preferably, the extracted models can be in JSON (JavaScript Object Notation) format, which is a data-interchange format including key-value pairs. After the models are extracted in block 251, depending on whether or not a user has selected any user preference rules, the models can be modified in accordance with the user selection in block 252. In some embodiments of the present invention, the ALMLS can test whether any user preference rules have been provided through the ALMLS interface. If a user has identified certain segment labels for the removal of a portion of a model set from the set of final models, then the existing set of models can be updated according to the user's selection in block 252.

These selections become particularly useful due to the additive nature of the core models. This additive nature entails that a particular individual log pattern could appear in multiple segments of training logs. Therefore, when a user intends to remove certain core models corresponding to the segment label provided, all the sets of log pattern models will be examined for each segment of training logs in block 252. Then, in block 252, the unique log pattern models specific to the segment label which the user intends to remove can be calculated so that those log patterns can then be removed. In this manner it can be ensured that the final set of core models will not contain any log patterns built from the training logs pertaining to the segment label provided by the user while at the same time keeping the remainder of the core models.

Once the existing models are updated in accordance with any applicable user selections in block 252, the new training logs can then be analyzed in block 253. A purpose of this analysis can be to reduce the number of training logs used in the adaptive learning process. Because operational IT systems often produce a large volume of repeated logs during their operation, many logs can be redundant. Therefore, it is highly likely that the existing log pattern models may still be applicable to the new training logs that include such redundant logs. Accordingly, these redundant logs can be filtered out prior to learning the new log pattern models. As noted earlier, this feature allows for a significant reduction of computational cost incurred in the process of adaptively learning new log analytics models.

The analysis of new logs in block 253 can be accomplished through regular expression matching. For example, a core model can be represented by a regular expression such as the on described above that can then be matched with new logs. In other words, given the list of existing core models, new logs can be matched against the list of regular expressions represented by those models in block 253. Then, in the preferred embodiments of the present invention, only those logs which are not matched to any of the existing core models will be retained to be used for learning new core models.

Embodiments of the present invention can use general log parsing engines to parse new training logs given the updated log pattern models from blocks 252 and 253. Given a regular expression represented by a log pattern model, a log parsing engine can parse the input log such that any input log is either matched to one of the extracted log patterns (by fitting one of the corresponding regular expressions) or is not matched at all. Subsequently, the unmatched logs can form the input for learning new log pattern models in block 254.

It should be understood that, in accordance with the preferred embodiments of the present invention, after having undergone the above described processes, the new heterogenous training logs of block 101 will now have been reduced to a much smaller set of unmatched new training logs because the majority of them would have been parsed by the updated log pattern models. New log pattern models can be found automatically from within the set of unmatched logs in block 254 through a Hierarchical Log Analyzer (HLA). The HLA includes a technique that uses an unsupervised approach to cluster the training logs with similar or identical patterns. Then, it can extract at least one of the common log patterns from one cluster. The HLA can form a hierarchical clustering structure so that the log patterns can be extracted from different layers of a hierarchical pattern tree. The granularity of log patterns can be controlled by the preset parameters in HLA. These extracted log patterns will become the new core models for the unmatched new training logs, where the models represent the new structures that were different from and not found among the old (existing) core models.

Having obtained a set of new core models, the new core models can be combined with the old core models to form the final core models in block 255. Before the new core model is combined with the existing core model from the previous training logs, model refinement can be performed if user indicates a model refinement request. The purpose of model refinement process is to make an adjustment, such as either adding elements to or removing elements from an existing core model, based on the user's preference or domain knowledge. For example, users may choose to merge multiple log patterns into one or split one log pattern into multiple patterns. This feature allows the embodiments of the present invention to combine machine intelligence with a user's domain knowledge for a better presentation of a log operation system. Thus, the final core model or the final set of core models will represent all of the underlying log patterns having incorporated the new core models from the new training logs. With a repeated iteration of the above processes, the final core models are able to capture all the log structures as the log analytics system is provided with new training logs during the course of its evolution.

Since the log analytics system can contain multiple models besides the core models, the learning mechanism can depend on the structural information of individual patterns. Therefore, once the final core models are generated, the new training logs can be parsed by ALMLS to obtain that structural information. In the same manner as it was done in block 253, the log parsing engine can parse the new training logs in block 256 to produce a structured and formatted output for each individual log which has been matched to one of the log patterns included in the final core model(s). The format of the parsed logs can be JSON format, which can also be the same format that is used in all of the previously described models extracted in block 151. Once the formatted outputs for the new training logs are produced, the can be used for the peripheral model learning process in block 106.

With the completion of the update and formatting of core models with new models obtained from the new training logs, the final models can become the final core models as the process of block 105 is completed in block 257. These final core models can then be used for the detection of system anomalies.

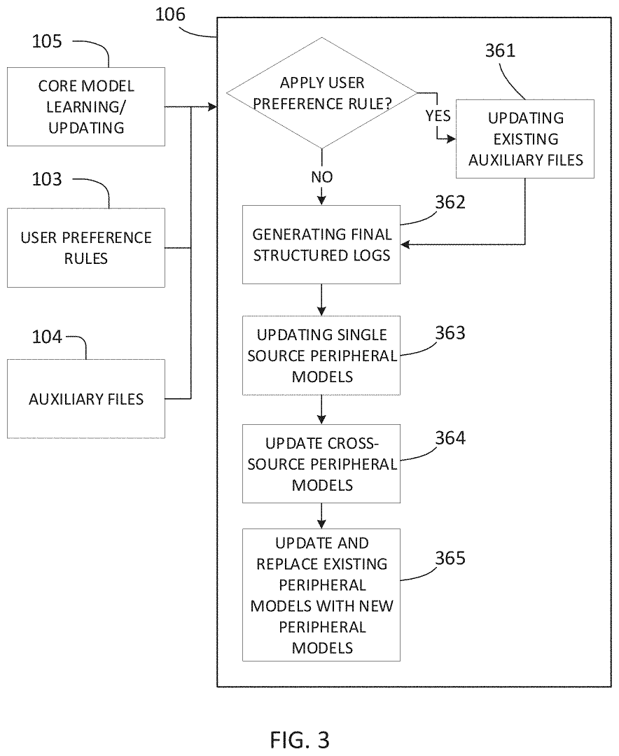

Turning now to FIG. 3, a block/flow diagram is depicted presenting the primary workflow of the peripheral model updating process of block 106 in accordance with an embodiment of the present invention. In general, the peripheral model updating process of block 106 takes the output of the core model updating process of block 105, the auxiliary files of block 104, and the optional user preference rules in block 103 and generates the final set of updated models. The peripheral model updating process can also store and manage the final set of update models in the model database.

With continued reference to FIG. 3, the peripheral model updating process of block 106 includes the use of auxiliary files of block 104. The auxiliary files of block 104 can include both the structured text logs which may have been parsed by the models discussed above and can be formatted in a JSON format as well as system performance measure logs such as CPU usage, memory usage, and the like in CSV (Comma Separated Values) format. In some embodiments of the present invention, a first set of auxiliary file can be produced by a normal model training of log analytics system. Afterwards, ALMLS can update the aforementioned auxiliary files. Through an iterative and recurring process, the auxiliary files can be accumulated and updates through multiple rounds of ALMLS processing.

The peripheral model updating process may utilize the auxiliary files in block 106 to update the peripheral models based on the output of the core model updating process of block 105. For example, both the current structured text logs and the logs from the previous trainings can be used for updating the content models because certain log patterns could exist in either or both of the new (additional) training logs and previous training logs. Therefore, ALMLS can produce a precise content model by combining the two sets of parsed text logs together. Meanwhile, any time-series-based models, such as sequence order models and invariant models, may employ the concatenation of both time series extracted from the new (additional) training logs and previous training logs in order to build models.

In some embodiments, each parsed text log can contain a field which denotes the corresponding segment of the training log. Because the performance logs may be in CSV format which does not have key-value pairs such as the ones in JSON format used for parsed text logs, ALMLS may artificially add a line to each segment of the performance logs so that it is possible to differentiate between different sets of logs.

If user preference rules were provided by users in block 103, then initially the process of peripheral model updating in block 106 can include updating the existing auxiliary files in block 361 in accordance with the rules selected by the user. Since the auxiliary files can contain label information, the process of removing those logs which contain the same labels that users intend to remove from the peripheral model updating process can be straightforward.

Once the existing auxiliary files are optionally updated with the user supplied rules, the current parsed text logs can then be combined with the updated auxiliary files to form the final structured text logs in block 362. For the performance-related CSV logs, the operation can include appending the current performance log onto the existing auxiliary performance logs. Once the final structured and parsed logs are generated, they can be used in the subsequent model updating processes of block 363 and blocks 364.

It should be appreciated that the various embodiments of the present invention can be configured to handle multiple sources of logs. Each source of such logs can have a set of core models and a set of peripheral models associated therewith. Accordingly, in block 363, embodiments of the present invention such as the ALMLS can update each set of peripheral models for each source. This set of particular peripheral models can include, but is not limited to, sequence models, ordering models, content models, statistical models, and time-series-related models. These models can characterize the operation systems from a variety of different perspectives so that together they are able to form a holistic view of the underlying system dynamics.

In accordance with an embodiment of the present invention, once all the single source peripheral models are updated, ALMLS can proceed to update the cross-source invariant models in block 364. The invariant modeling process requires the time series extracted from both text logs and performance logs across multiple log sources to combine them together to build invariant models which characterize the interdependence of different logs sources. The auxiliary files can contain at least one set of time series that has been accumulated through multiple rounds of ALMLS processing. The current additional training log can form another set of time series that can then be added to the auxiliary files. These two sets of time series can be combined. Embodiments of the present invention can use a variety of applicable techniques to extract the invariant dependence information in block 364.

Once the above-mentioned model updating procedures are completed, the updated models can replace the old models and can be stored, indexed, searched and managed in block 365. It is readily contemplated that embodiments of the present invention may employ any suitable software and search engines for model management purpose. Both the core models and peripheral models can be in JSON format and can be populated into a model database. Searchable databases and search engines can provide a flexible and versatile interface so that embodiments of the present invention such as ALMLS can interact with them. Once the models are populated to the databases and search engines, they can be used for visualization for inspection purposes as well as indexed for the log analytics system anomaly detection process of block 108.

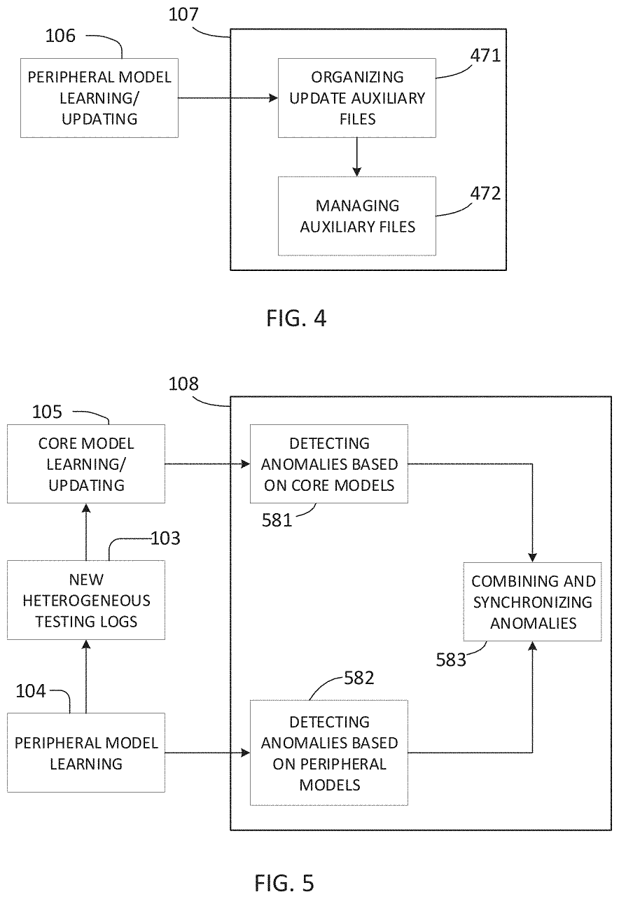

Referring now to FIG. 4, a block/flow diagram is depicted therein showing the generation of updated auxiliary files, in accordance with an embodiment of the present invention. In block 107, the process of generating updated auxiliary files can include managing the files to prepare them for a subsequent ALMLS processing. The management can include organizing the auxiliary files so that they can be in an accessible location for future ALMLS processing.

The auxiliary files can contain both parsed text logs in JSON format as well as performance logs in CSV format. The files can be organized in block 471 in a manner such that each log source contains two types of file if both the text logs and performance logs are available. One type of file can be the combined parsed text logs which contain text logs from multiple segments of training or additional learning logs. The other type of auxiliary files can be the performance logs which combine multiple CSV files with added labels to differentiate between the different segments of the logs.

Additionally, the management of the auxiliary files can include their storage. Since these files can be used in subsequent rounds of ALMLS processing, it is preferable that they are well organized and accessible. In preferred embodiments of the present invention, ALMLS can use a networked file system to store the auxiliary files based on the log sources in block 472 such that each log source has its own auxiliary files organized and categorized in a corresponding manner. It should be understood by one skilled in the art that once they are updated, stored, and organized, the auxiliary files can then again be used in subsequent rounds of ALMLS processing.

It should be noted that the auxiliary files can be used to define the relationships between the core models and the peripheral models. Because in some embodiments of the present invention the peripheral models are built on top of the core models in the sense that the peripheral models are logically related to corresponding core models, the auxiliary files facilitate in defining that relationship. For example, supposing a situation where a core model A is always followed by core model B, a peripheral model can include statistical or duration information about the relationship between core model A and core model B (e.g., core model A is always followed by core model B). For example, if core model A and core model B describe certain IT system events or state that follow each other a certain percentage of the time but not all the time, that information can be included in a peripheral model. Alternatively, a peripheral model can include duration information related to the duration or timespan between events modeled by two different core models. For example, if core model 1 indicates the start of a given task and core model 2 indicates the completion of that task, a peripheral model can contain information about the maximum and minimum duration of time between the start and completion of the task.

Referring now to FIG. 5, a block/flow diagram is depicted therein showing the process of system anomaly detection, in accordance with an embodiment of the present invention. After the updating of the core models and the peripheral models is complete, system anomaly detection can be performed in block 108 using new testing logs from block 109 as inputs. Notably, the testing logs can be in the same format as the one used for the testing logs in block 101.

In embodiments of the present invention, anomaly detection based on the updated core models can determine if any log messages in the new testing logs cannot be parsed by the core models. The log parsing engine described previously can be used in block 581 to parse the new testing logs by using the updated core models. If the log parsing engine fails to parse a given log message, then that log message can be identified as an anomaly by virtue of containing a previously unencountered log pattern that may not have previously existed in the training logs.

A similar process can be performed with the peripheral models to detect anomalies in block 582. However, because the peripheral models can contain both single log source models and cross-source log models, the anomaly detection may be performed separately for each type of peripheral model (i.e., single source and cross-source).

In block 583, the anomalies that were detected in blocks 581 and 582 can be combined. It should be noted that because it is possible that a particular log message could be detected as an anomaly in both block 581 and block 582, the duplicate detections can be removed from the outputs in block 582. Then, the results can also be synchronized in accordance with the time stamps in the anomalous log messages and the output can be stored in a JSON format file. Notably, the detected anomalies may indicate a system fault or error in the operation of the IT system or one of its components. Alternatively, an anomaly may indicate a previously unencountered normal operative state of the IT system. However, in the case that the detected anomaly indicates an error or a fault, appropriate corrective action can be taken either automatically or by users of the IT system or the ALMLS in order to remedy the cause of the anomaly. Corrective actions that may be take as a result of detecting an anomaly include, but are not limited to, changing a setting (e.g., security setting, user interface setting, etc.) for an application or hardware component of the IT system, changing an operational parameter of an application or hardware component (for example, an operating speed or data transfer rate) of the IT system, halting (stopping) and/or restarting an application of the IT system, halting and/or rebooting a hardware component of the IT system, changing an environmental condition that affects the operation of the IT system, changing the IT system's network interface's status or settings, and the like.

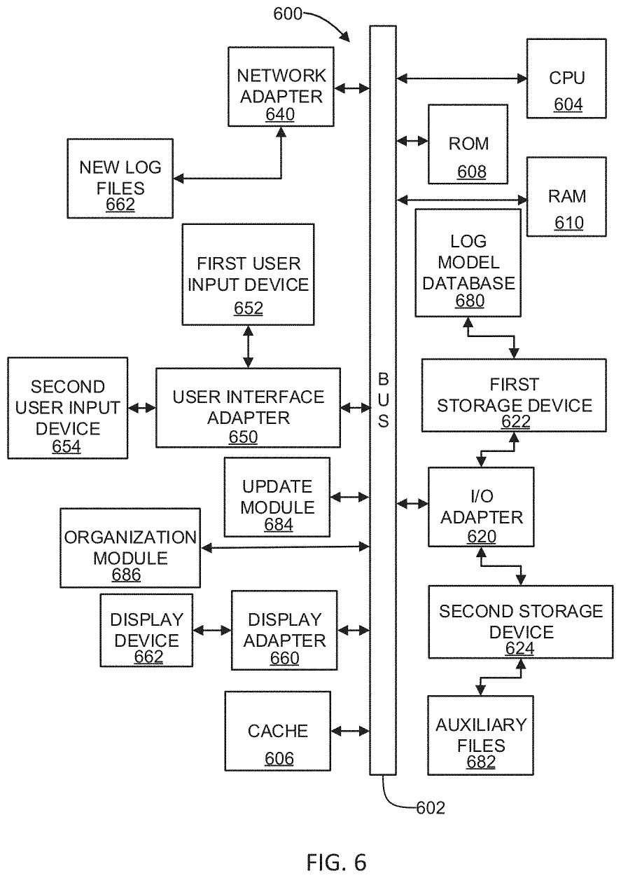

An illustrative representation of an exemplary computing device/processing system for adaptive and continuous log learning in accordance with an embodiment of the present invention is shown in FIG. 6. The computing device 600 can generally be comprised of a Central Processing Unit (CPU) 604, interchangeably referred to herein as a processor or a processor device, operatively coupled to other components via a system bus 602, optional further processing units including a graphics processing unit (GPU), a cache, a Read Only Memory (ROM) 608, and a Random Access Memory (RAM) 610. The computing device 600 can also include an input/output (I/O) adapter 620, a sound adapter, a network adapter 640, a user interface adapter 650, and a display adapter 660, all of which may be operatively coupled to the system bus 602.

Additionally, a first storage device 622 and a second storage device 624 can be operatively coupled to system bus 602 by the I/O adapter 620. The storage devices 622 and 624 can be any of a disk storage device (e.g., a magnetic or optical disk storage device), a solid state magnetic device, and so forth. It should be appreciated that the storage devices 622 and 624 can be the same type of storage device or different types of storage devices. Although it is contemplated that any of log files, log models, and auxiliary files can be stored on any type of storage device or media, the depicted exemplary device shows that the first storage device 622 stores a log model database 680. Further, new log files 662 may be located on a remote location accessible via a network adapter 640. The auxiliary files 628 may be stored on the second storage device 624. It should be readily understood by one skilled in the art that any combination of storage locations of the model databases, testing and training logs, as well as the auxiliary files are consistent with the scope of the teaching herein.

In some embodiments, the device 600 may include a mother board, alternatively/additionally a different storage medium (e.g., hard disk drive, solid state drive, flash memory, cloud storage), an operating system, one or more application software and one or more input/output devices/means, including one or more communication interfaces (e.g., RS232, Ethernet, Wifi, Bluetooth, USB). Useful examples of applicable devices for use in embodiments od the present invention include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

It should be understood that the systems of an embodiment of the present invention can include one or more functional modules that may, in some embodiments, be implemented as software that is stored in memory 622, 624 and executed by hardware processor 604. In other embodiments, one or more of the functional modules may be implemented as one or more discrete hardware components in the form of, e.g., application-specific integrated chips or field programmable gate arrays. An exemplary embodiment may include an update module 684 and an anomaly detection module 686 as discrete components communicable connected to each other as well as the remaining components of IT system 600 via the bus 602. In accordance with the processes described above, update module 684 can obtain new training log files 662 to update the core models and peripheral models from the log model database 680. The update module can also incorporate the auxiliary files 682 in the process of updating the peripheral models. It should be understood that update module 684 can be configured to perform the processes related to blocks 105 and 106 described above in the discussion of FIG. 1. Analogously, anomaly detection module 686 can be configured to perform the processes related to block 108 described above in the discussion of FIG. 1. Furthermore, a person skilled in the art would appreciate that although the log model database 680, the auxiliary files 682, as well as the new log files 662 are depicted in FIG. 6 as being located in different storage devices, alternative embodiments of the present invention can have them all or some combination of them be located on the same storage device.

Accordingly, in some embodiments a first user input device 652 and a second user input device 654 may be operatively coupled to system bus 602 by user interface adapter 650. The user input devices 652, 654, and 656 can be any of a keyboard, a mouse, a keypad, an image capture device (e.g., a camera), a motion sensing device, a microphone, a touch-sensitive device (e.g., a touch screen or touchpad), a device incorporating the functionality of at least two of the preceding devices, and so forth. Of course, other types of input devices can also be used, while remaining within the scope and spirit of the present invention. The user input devices 652, 654, and 656 can be the same type of user input device or different types of user input devices. The user input devices 652, 654, and 656 may be used to input and output information to and from system 600.

Of course, the processing system/device 600 may also include other elements (not shown), as readily contemplated by one of skill in the art, as well as omit certain elements. For example, various other input devices and/or output devices can be included in processing system 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 600 are readily contemplated by one of ordinary skill in the art given the teachings of the present invention provided herein.

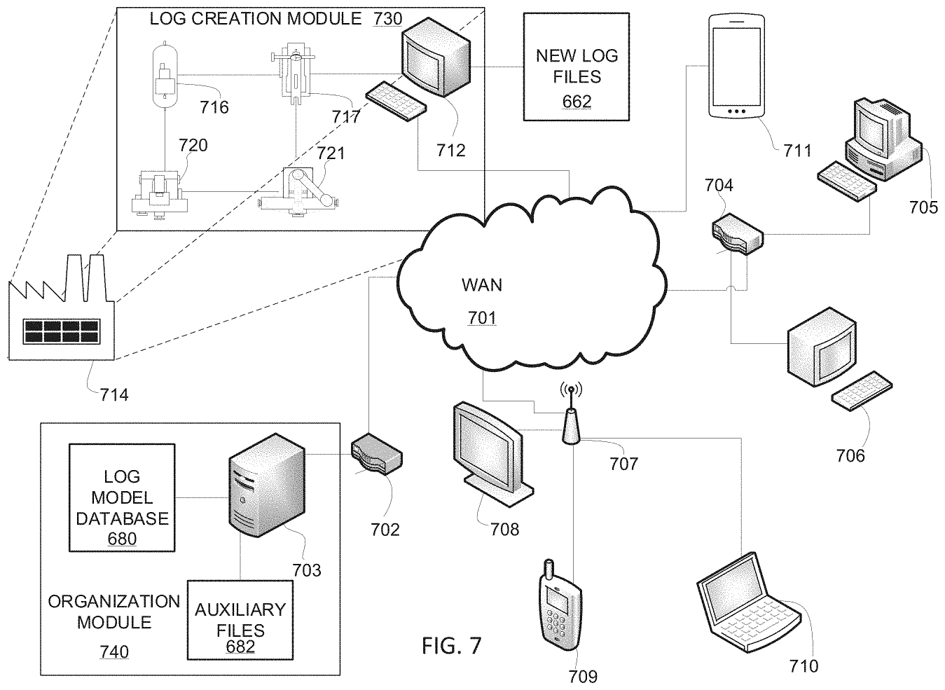

Referring to FIG. 7, a schematic overview of a system for adaptive and continuous log learning in accordance with an embodiment of the invention is shown. The system is comprised of one or more data servers 703 for electronically storing information used by the system. In some embodiments of the present invention, server 703 can include the log model database 680 and can also store the auxiliary files 682. Applications or programs in the server 703 may retrieve and manipulate information in storage devices and exchange information through a WAN 701 (e.g., the Internet). Applications or programs in server 703 may also be used to manipulate information stored remotely and process and analyze data stored remotely across a WAN 701 (e.g., the Internet).

According to an exemplary embodiment, as shown in FIG. 7, exchange of information through the WAN 701 or other network may occur through one or more high speed connections. In some cases, high speed connections may be over-the-air (OTA), passed through networked systems, directly connected to one or more WANs 701 or directed through one or more routers 702. Router(s) 702 are completely optional and other embodiments of the invention may or may not utilize one or more routers 702. One of ordinary skill in the art would appreciate that there are numerous ways server 703 may connect to WAN 701 for the exchange of information, and various embodiments of the invention are contemplated for use with any method for connecting to networks for the purpose of exchanging information. Further, while this application refers to high speed connections, embodiments of the invention may be utilized with connections of any speed.

Components, elements, or modules of the system may connect to server 703 via WAN 701 or other network in various ways. For instance, a component or module may connect to the system (i) through a computing device 712 directly connected to the WAN 701, (ii) through a computing device 705, 706 connected to the WAN 701 through a routing device 704, (iii) through a computing device 708, 709, 710, connected to a wireless access point 707, or (iv) through a computing device 711 via a wireless connection (e.g., CDMA, GMS, 3G, 4G, 5G) to the WAN 701. One of ordinary skill in the art will appreciate that there are numerous ways that a component or module may connect to server 703 via WAN 701 or other network, and embodiments of the invention are contemplated for use with any method for connecting to server 703 via WAN 701 or other network. Furthermore, server 703 could be comprised of a personal computing device, such as a smartphone, acting as a host for other computing devices to connect to.

Users of the system in accordance with embodiments of the present invention can interact with the system via computing devices such as a laptop 710, personal computers 705, 706, 708, cell phones 709, smart phones 711, and the like. The exemplary system in accordance with some embodiments of the present invention can include a power plant or factory 714. The factory 714 can include a variety of different interlinked sensors 716 and 717 that can detect and indicate different measurements and states as well as record such states and measurements in operational logs. The factory 714 can include a variety of specialized operational devices 720 and 721 that are networked and communicatively connected to the sensors 716 and 717 as well as to computing device 712 in which the specialized operational devices 720 and 721 may store logs indicative of their operation as log files 662.

In some embodiments of the present invention a communicatively connected group of devices including sensors 716 and 717, specialized operational devices 720 and 721, and computing device 712 can be included as constituent elements in a log creation/generation module 730 configured to generate logs of the operation of an IT system such as factory 714. These logs can then serve as training logs and testing logs to be used in conjunction with the core and peripheral models in the remaining elements of embodiments of the present invention such as ALMLS. Other embodiments of the invention may further comprise an organization module 740 which may be configured to format, organize, index, and otherwise prepare the updated models, auxiliary files, and log files for use in subsequent rounds of ALMLS processing after a round of updating has been completed. Analogous to the other modules discussed previously, log generation/creation module 730 and organization module 740 can be implemented as software executed by a processing device or as one or more discrete hardware components.

The communications means of the system, according to embodiments of the present invention, may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, or any combination thereof. One of ordinary skill in the art will appreciate that there are numerous communications means that may be utilized with embodiments of the invention, and embodiments of the invention are contemplated for use with any communications means.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for adaptive and continuous log model learning comprising:
updating, by a processor device, a core model to generate an updated core model based on a heterogeneous training log file, each of the core model and the updated core model being a syntactic model and being additive in nature;
updating a peripheral model, the peripheral model representing a relationship between core models, using a set of existing auxiliary files, the existing auxiliary files defining a relationship between existing models, and the updated core model to generate an updated peripheral model based on the heterogeneous training log file; and
detecting, with the updated core model and the updated peripheral model, an anomaly within a set of testing logs indicative of information technology system operation to take remedial action on the information technology system based on a most recent model update.

2. The method as recited in claim 1, further comprising updating, by the processor device, the set of existing auxiliary files to generate a set of updated auxiliary files.

3. The method as recited in claim 1, wherein the core models comprises a syntactic log model.

4. The method as recited in claim 1, wherein the peripheral model is selected from the group consisting of semantic content models, statistical models, sequence models, ordering models, and cross-component invariant relationship models.

5. The method as recited in claim 1, wherein updating the core model includes extracting a set of existing models into local files.

6. The method as recited in claim 1, wherein updating the core model includes filtering out redundant logs by analyzing the training logs, identifying repeated logs generated during an operative phase of the information technology system, and retaining unmatched logs.

7. The method as recited in claim 6, wherein updating core model further includes creating a new core model based on the unmatched logs and combining core model with the core model.

8. The method as recited in claim 1, wherein updating the peripheral model includes updating a single source peripheral model and a cross-source invariant model using information contained in the auxiliary files.

9. The method as recited in claim 2, further including organizing, formatting, or indexing the updated core model, updated peripheral model, and updated auxiliary files on a memory device for access by a subsequent log model learning process.

10. The method as recited in claim 1, wherein the remedial action is selected from the group consisting of changing a security setting for an application or hardware component of the information technology system, changing an operational parameter of an application or hardware component of the information technology system, halting or restarting an application of the information technology system, halting or rebooting a hardware component of the information technology system, changing an environmental condition of the information technology system, and changing status of a network interface of the information technology system.

11. The method as recited in claim 1, wherein detecting anomalies within a set of testing logs indicative of information technology system operation using the updated core model and the updated peripheral model includes parsing the testing logs with the updated core model.

12. A computer system for adaptive and continuous log model learning, comprising:
a processor device;
at least one database storing log models;
at least one log file storage;
at least one auxiliary file storage;
an update module configured to:
update a core model to generate an updated core model based on a heterogeneous training log file, each of the core model and the updated core model being a syntactic model and being additive in nature, and
update a peripheral model, the peripheral model representing a relationship between core models, using a set of existing auxiliary files, the existing auxiliary files defining a relationship between existing models, and the updated core model to generate an updated peripheral model based on the heterogeneous training log file; and
an anomaly detection module configured to:
detect, with the updated core model and the updated peripheral model, anomalies within a set of testing logs indicative of information technology system operation.

13. The system as recited in claim 12, wherein the update module is further configured to update the set of existing auxiliary files to generate a set of updated auxiliary files.

14. The system as recited in claim 12, wherein the log models stored in the at least one database comprise a core model including a syntactic log model, and a peripheral model selected from the group consisting of a semantic content model, a statistical model, a sequence models, an ordering model, and a cross-component invariant relationship model.

15. The system as recited in claim 12, configured to filter out redundant logs by analyzing training logs contained in the training log file, identifying repeated logs generated during an operative phase of the information technology system, and retaining unmatched logs.

16. The system as recited in claim 12, wherein the anomaly detection module detects anomalies at least in part by parsing the testing logs with the set of updated core models.

17. A computer program product for adaptive and continuous log model learning, the computer program product comprising a non-transitory computer readable storage medium having program instructions embodied therewith, the program instructions executable by a computing device to cause the computing device to:
update a core model to generate an updated core model based on a heterogeneous training log file, each of the core model and the updated core model being a syntactic model and being additive in nature, and
update a peripheral model, the peripheral model representing a relationship between core models, using a set of existing auxiliary files, the existing auxiliary files defining a relationship between existing models, and the updated core model to generate an updated peripheral model based on the heterogeneous training log file; and
an anomaly detection module configured to:
detect, with the updated core model and the updated peripheral model, anomalies within a set of testing logs indicative of information technology system operation to take remedial action on the information technology system based on a most recent model update.

18. The product as recited in claim 17, wherein the program instructions are further executable by a computing device to cause the computing device to update the set of existing auxiliary files to generate a set of updated auxiliary files.

19. The product as recited in claim 17, wherein the program instructions are further executable by a computing device to cause the computing device to filter out redundant logs by analyzing the training logs, identifying repeated logs generated during an operative phase of the information technology system, and retaining unmatched logs.

20. The product as recited in claim 17, wherein the program instructions are further executable by a computing device to cause the computing device to parse the testing logs with the updated core model to detect an anomaly.
